(19) United States
(12) Patent Application Publication
(10) Pub. No.: US 2020/0086475 A1
(43) Pub. Date: Mar. 19, 2020

(54) APPARATUS FOR MOUNTING A TOOL TO A VICE

(71) Applicant: Andrew BIRCH, Thetford (GB)

(72) Inventor: Andrew BIRCH, Thetford (GB)

(21) Appl. No.: 16/493,993

(22) PCT Filed: Mar. 14, 2018
(86) PCT No.: PCT/GB2018/050644

§ 371 Date: Sep. 13, 2019

(30) Foreign Application Priority Data
Mar. 14, 2017 (GB) 1704036.1

(51) Int. Cl. B25H 1/00; B25B 1/24; B25H 1/10

(52) U.S. Cl. CPC B25H 1/0021; B25H 1/10; B25B 1/2484

(57) ABSTRACT

An apparatus for mounting a power tool to a vice, e.g. a vice-cum-workbench such as a Black and Decker™ Workmate™, is disclosed.

The apparatus includes a support that may be releasably attached to or an integral part of the power tool. The support comprises one or more projections that when the tool is placed on top of the vice depend down for retainment by the vice's jaws, thereby rigidly supporting the power tool to the vice.

The projections are retractable, e.g. through a pivoting action, in order that they do not destabilize the tool when it's supported on a surface other than a vice. The projections may be arranged to retract under the weight of the tool upon it.

### CROSS-REFERENCE TO RELATED APPLICATIONS

This application is based upon and claims priority to PCT Patent Application No. PCT/GB2018/050644 filed on 14 Mar. 2018, which is based upon and claims priority to GB Patent Application No. 1704036.1 filed on 14 Mar. 2017; the collective disclosure of which being hereby incorporated by reference in its entirety.

### BACKGROUND

When operating a portable power tool it can be desirable beforehand to temporarily attach the tool to a supporting surface, such as portable workbench, to ensure the tool remains secured in a fixed position during use.

WO8402102 relates to a power tool support device for use with a workbench-cum-vice. The support comprises a plate arranged to be seated and held between the jaws of the vice. A power saw is arranged to be mounted below the plate so that its blade projects upwards through a slot provide within the plate. The weight of the tool and it use gives rise to a downward sheering forces on the plate with respect to the direction of the gripping force of the jaws which may lead to movement of the plate within the jaws.

EP0517582 relates to a jig comprising T-shaped blocks that are screwed to an underside of the jig. In use, the T-shaped blocks are arranged to be held between jaws of a workbench-cum-vice to retain the jig to the workbench. The jig includes a hole 28A for holding a column of a drill stand in a vertical orientation. The base of the column rests directly on the T-block and will exert a downward force directly thereon during use which may force the T-block from the jig.

### BRIEF SUMMARY

In a first aspect there is provided apparatus including a tool adapted to be retained on a vice having vice jaws defining a supporting surface and gripping surfaces. The apparatus comprises a projection attached to the tool and arranged such that when the tool is supported for use on the supporting surface, to allow at least one of the gripping surfaces to be tightened against it to retain the tool to the vice. The projection may be moveable relative the tool, e.g. retractable, in order that it can be supported by the tool in a stowed position when the tool is not being retained on the vice.

In another aspect there is provided a tool adapted to be retained on a vice having vice jaws defining a supporting surface and gripping surfaces. The tool comprises a projection, which may be retractable, arranged, when the tool is supported for use on the supporting surface, to allow at least one of the gripping surfaces to be tightened against it to retain the tool to the vice. The projection may be moveable relative the tool in order that it can be supported by the tool in a stowed position when the tool is not being retained on the vice.

In a further aspect there is provided a tool adapted to be retained on a vice having vice jaws defining a supporting surface and gripping surfaces; the tool comprising a projection arranged, when the tool is supported on the supporting surface, to allow at least one of the gripping surfaces to be tightened against it to retain the tool to the vice; and wherein when the tool is mounted to the vice, the projection is substantially isolated from the weight of the tool.

The following preferred features may apply to any of the aspects above.

Through use of the invention, a portable power tool can be temporarily secured against a vice using the vice's clamping action, the supporting surface providing a stable base to carry the weight of the tool. The projection can be moved into a stowed position, e.g. on/against/in the tool when the tool is to be mounted on a surface other than provided by the vice, e.g. the floor or a table, where it might otherwise destabilise the tool. Favourably the projection can retract into the stowed position.

Typically the supporting surface is provided by a top surface of the vice jaws. The tool can be positioned directly on top of the support surface. The supporting surface of the vice jaws may provide a work surface e.g. of a portable workbench akin to the Black and Decker™ Workmate™.

It is favourable that the projection is arranged so as to be moveable between a retracted position and an extended position. Favourably the projection can move between a retracted position and an extended position without being detached from the tool.

The projection may be arranged for movement between an extended position in which it extends below a base of the tool, and a retracted position. Favourably the projection is adapted to retract towards, through and/or beyond a plane that coincides with a mounting surface of the tool that, when mounted on the vice, lies against the supporting surface of the vice jaws. As such the protrusion can be arranged to retract so as not to extend beyond the surface of the tool.

The protrusion may be arranged to retract in response to the weight of the tool being placed upon it. In this way the protrusion can automatically retract when the tool is placed on the ground.

The projection may be rotatably connected to the tool. This provides a convenient means to enable the projection to move between a retracted position and an extended position.

The projection may be arranged to move from the retracted position to the extended position under gravity.

The projection may be attached directly to the tool, e.g. to its casing so as to extend below the base of the tool. The projection may be releasably attachable to the tool. This allows the projection to be swapped between tools.

The projection may comprise a portion arranged, when the tool is retained by the vice, to extend across a side of at least one of the vice jaws that is opposite the supporting surface. Typically this is the underside of the vice jaws. This inhibits unwanted loosening of the tool from the vice during use of the tool.

The apparatus (and optionally the tool) may comprise two retractable projections arranged such that a first jaw of the vice jaws tightens against a first of the two projections and a second jaw of the vice jaws tightens again a second of the projections.

The projection(s) may be arranged to extend between the vice jaws. Alternatively the projections may be arranged such that the jaws lie between the projections. In the latter case, the jaws may be opened such that outer gripping faces of the jaws are tightened against the projections.

The supporting surface and gripping surfaces of the vice may lie in planes that are substantially perpendicular from one another. The supporting surface may be provided by first and second co-planer supporting surfaces of respective vice jaws. The tool may be arranged, when in use, to be supported by both first and second surfaces.

The tool may comprise a tool mechanism, for working on a work piece. For example where the tool is a saw, the tool mechanism may include the saw blade and means (e.g. an electric motor), if any, for moving the saw towards or away from the work piece. Where the tool is a drill, the mechanism may include the drive mechanism and where in use a chuck and bit.

The tool may comprise a support which includes the projection and that provides a mounting surface about which the tool is seated on the supporting surface of the vice. The tool mechanism may be arranged on a first side of the support and the projection arranged to extend away from a second side of the support. As such the support may provide a base for the tool.

The projection may be arranged so that it can move into a stowed position retained to the support, e.g. against or in the support. The projection may be arranged to retract towards or into the support. The projection may be hinged for rotation relative to the support.

The support may be releasable attachable to the tool. When attached to the tool the support is favourably rigidly attached to the tool. Alternatively the support may be integrally formed with the tool, e.g. provided by a portion of the casing of the tool that provides a base of the tool.

The support may comprise retaining means to retain a fastener for fastening the support to a body of the tool, the retaining means allowing the fastener, e.g. a threaded nut, to move across a side of the support that faces the tool body. The support may comprise a rail, the fastener being free to move along the rail in order provide means to allow the fastener to align with a corresponding fastening element (e.g. a bolt) provided by the tool.

The support may comprise a first side that, when in use, faces the vice and a second side that faces a tool body, and wherein the support is extendable such as to increase a dimension of the first and second sides. This enables the support to be adapted to fit different sizes of tool. To provide extendibility, the support may comprise a telescopic mechanism.

The tool may be arranged to extend across spaced apart vice jaws so as to be supported by a supporting surface defined by both vice jaws.

The support may include one or more elongate members which when in use may be spaced apart on either side of the mounting surface.

In another aspect there is provided a support arranged for attachment to a tool, e.g. the base of a tool, the support defining a surface, which when mounted to the tool provides a mounting surface for mounting the support to a supporting surface of a vice; the support comprising a retractable projection arranged, when the tool is mounted to the vice, to be gripped by at least one of the vice jaws to retain the tool to the vice.

The support may include one or more elongate member which when in use may be spaced apart on either side of the mounting surface.

The tool may be arranged on a first side of the support and the projection arranged to extend away from a second side of the support.

The projection may be arranged so that it can move into a stowed position retained to the support, e.g. against or in the support. The projection may be arranged to retract towards or into the support. The projection may be hinged for rotation relative to the support.

The support may be releasable attachable to the tool. Alternatively the support may be integrally formed with the tool, e.g. provided by a portion of the casing of the tool that provides a base of the tool.

The support may comprise retaining means to retain a fastener for fastening the support to a body of the tool, the retaining means allowing the fastener, e.g. a threaded nut, to move across a side of the support that faces the tool body. The support may comprise a rail, the fastener being free to move along the rail in order provide means to allow the fastener to align with a corresponding fastening element (e.g. a bolt) provided by the tool.

The support may comprise a first side that, when in use, faces the vice and a second side that faces a tool body, and wherein the support is extendable such as to increase a dimension of the first and second sides. This enables the support to be adapted to fit different sizes of tool. To provide extendibility, the support may comprise a telescopic mechanism.

The tool may be arranged to extend across spaced apart vice jaws so as to be supported by a supporting surface defined by both vice jaws.

The support may include one or more elongate member which when in use may be spaced apart on either side of the mounting surface.

In a further aspect there is provided a method for supporting a portable power tool on a vice having vice jaws defining a supporting surface and clamping surfaces; the method comprising arranging the tool to be supported against the supporting surface and tightening at least one of the vice jaws against a projection of the tool to retain the tool to the vice.

### BRIEF DESCRIPTION OF THE DRAWINGS

The accompanying figures in which like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a perspective view of a first embodiment of a crossbar of a vice support for supporting a power tool to a vice;

FIG. 2 is a perspective view the vice support of FIG. 1 supporting a mitre saw to a bench vice;

FIG. 3 is a side view section of the mitre saw with vice support of FIG. 1;

FIG. 4 is a side section view of the mitre saw with vice support of FIG. 1;

FIG. 5 is an end view section of the vice support supporting the mitre saw;

FIG. 6 is a side view of the mire saw with vice support of FIG. 1 seated on the ground with swing arms retracted;

FIG. 7 is a perspective view of the vice support supporting a mitre saw to a vice with an alternative arrangement of swing arms;

FIG. 8 is a perspective view a second embodiment of vice support supporting a mitre saw to a vice; and

FIG. 9 is a perspective view an alternative arrangement of the second embodiment of vice support supporting a mitre saw to a vice.

### DETAILED DESCRIPTION

As required, detailed embodiments are disclosed herein; however, it is to be understood that the disclosed embodiments are merely examples and that the devices and methods described herein can be embodied in various forms. Therefore, specific structural and functional details disclosed herein are not to be interpreted as limiting, but merely as a basis for the claims and as a representative basis for teaching one of ordinary skill in the art to variously employ the disclosed subject matter in virtually any appropriately detailed structure and function. Further, the terms and phrases used herein are not intended to be limiting, but rather, to provide an understandable description. Additionally, unless otherwise specifically expressed or clearly understood from the context of use, a term as used herein describes the singular and/or the plural of that term.

The terms “a” or “an”, as used herein, are defined as one or more than one. The term “plurality”, as used herein, is defined as two or more than two. The term “another”, as used herein, is defined as at least a second or more. The terms “including” and “having,” as used herein, are defined as comprising i.e., open language. The term “coupled,” as used herein, is defined as “connected,” although not necessarily directly, and not necessarily mechanically.

It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

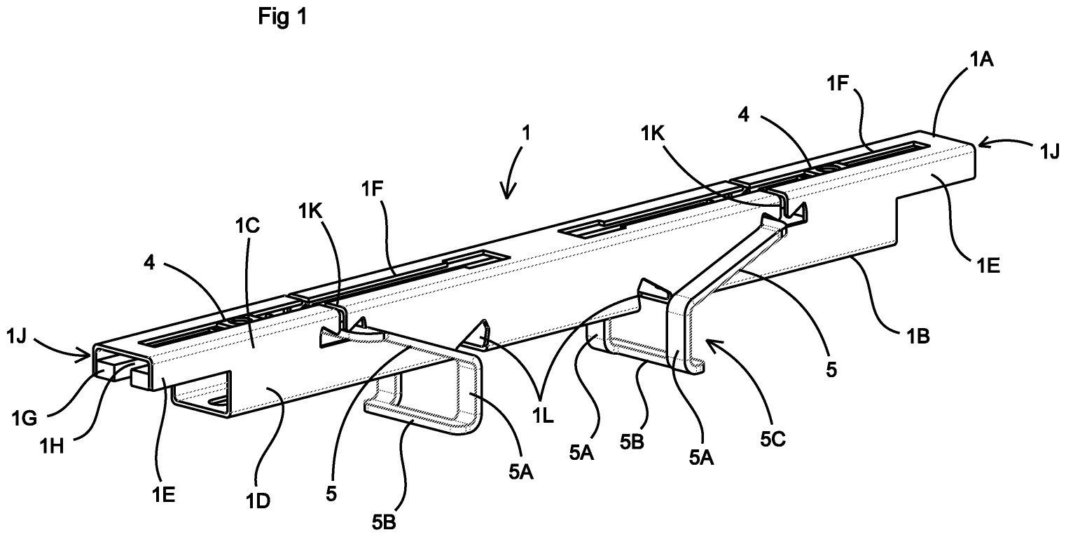

With reference to FIG. 1 there is a shown a crossbar 1 which together with a second identical crossbar provides a vice support for mounting a power tool 2 to a vice 3.

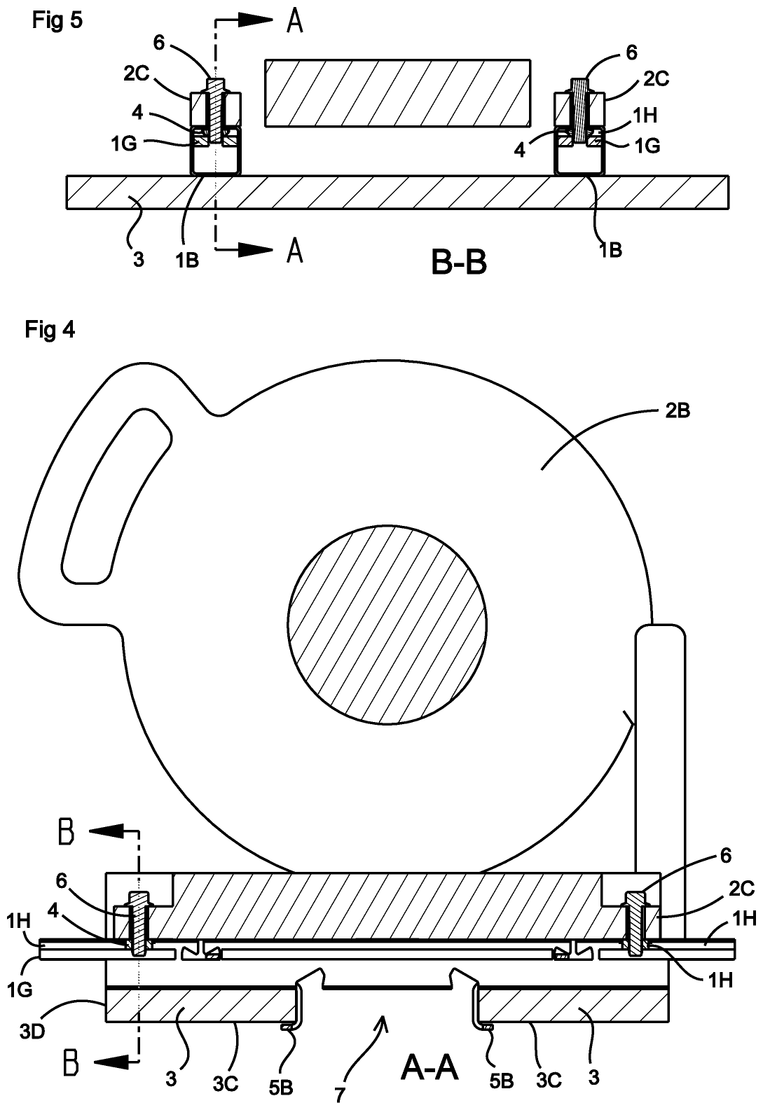

The crossbar 1 is of elongate form and comprises relatively flat upper and lower sides 1A 1B. The cross-bar 1 has an upper portion 1C and a lower portion 1D. The upper portion 1C is longer than the lower portion such as to define end portions 1E that extend longitudinally beyond the lower portion 1D. The upper portion 1C comprises longitudinally extending slots 1F in upper side 1A. Extending longitudinally within the crossbar facing the slots 1F is a rail 1G. The slots 1F open into a longitudinally cavity 1H lying between the slots 1F and rail 1G within the upper portion 1C. Openings 1J in each end face of end portions 1E provide access to the cavity 1H for seating of fastening nuts 4 (seen more clearly in FIGS. 4 & 5).

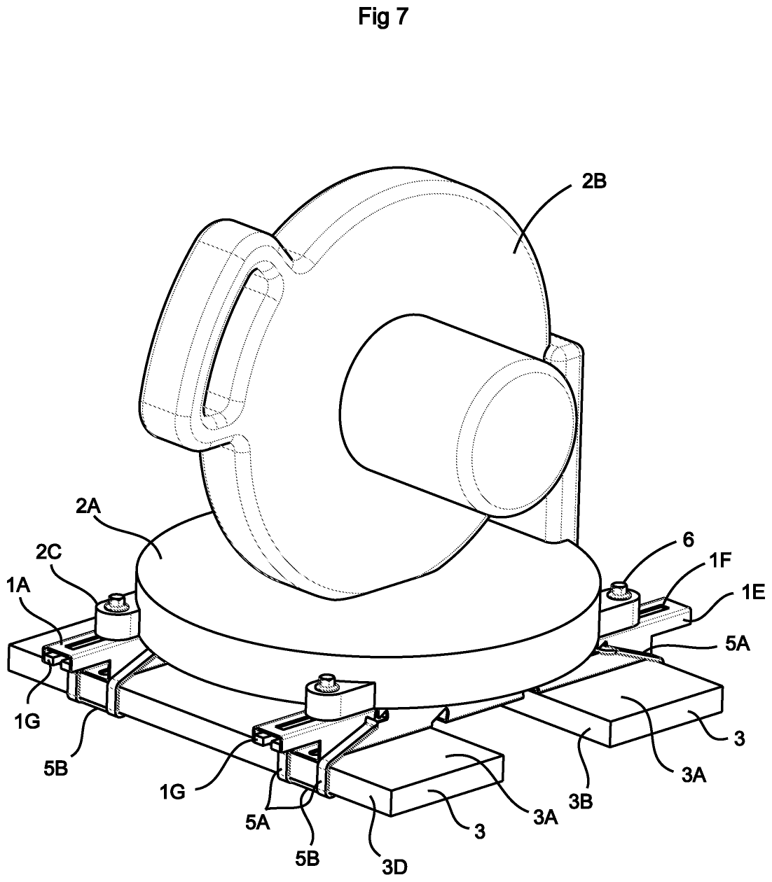

The cross bar 1 further comprises a first pair of spaced laterally extending slots 1K that extend from the upper side 1A of the crossbar 1 towards the lower side 1B and a second pair of slots or cut outs 1L extending from a lower side 1B of the crossbar 1 towards the upper side 1A. Each of the first pair of slots 1K provides a mount for carrying a swing arm 5. The swing arms 5 comprise arms 5A that lie on either side of the crossbar, an upper crosspiece (not shown) that lies within and extends across the slot 1K to connect the upper ends of arm 5A, and lower crosspiece 5B that connects the lower ends of the arm 5A, the lower cross pieces extend laterally across lower surface 1B of cross piece 1. The arms are shaped to provide hook having an opening 5B. The swing arms may be removed from the slots 1K in order to be reorientated to face the opposite directions as shown in FIG. 7.

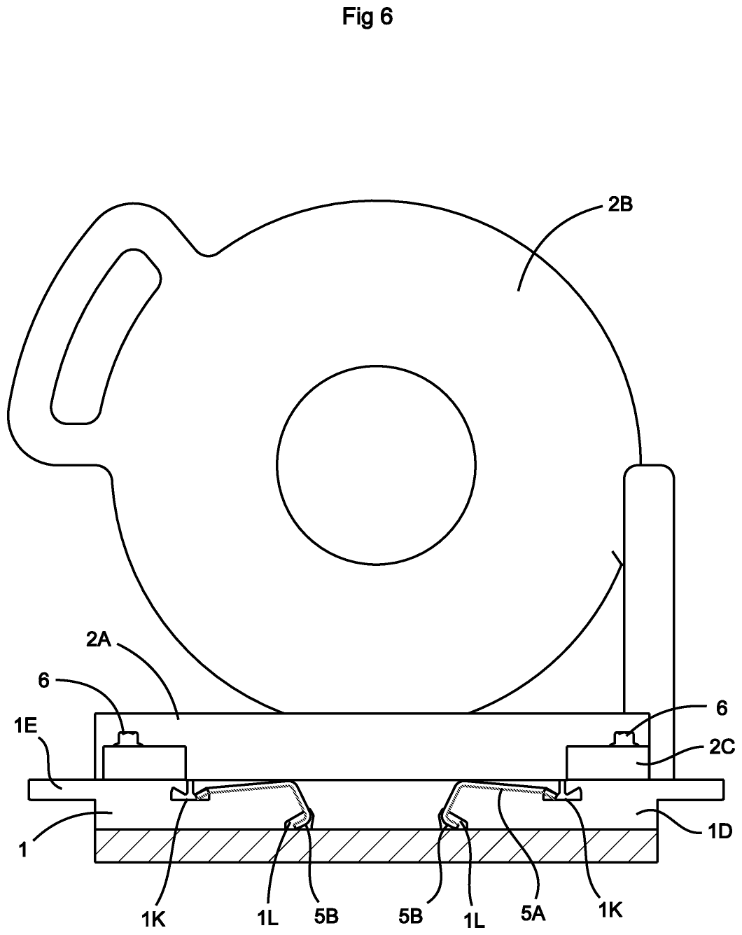

The swing arms 5 are seated and retained in the base of the slots 1K so as to be free to rotate relative to the crossbar 1 about an axis lying substantially perpendicular to the longitudinal axis of the crossbar 1. This allows the swing arms 5 to rotate between an extended position, shown in FIG. 1 in which the swing arms depend below lower surface 1B, and a retracted position shown in FIG. 6, in which the swing arms lie above/or flush with the lower surface 1B, with a lower crosspiece 5A of the swing arms sitting within respective slots 1L in the lower face 1B of the crossbar 1.

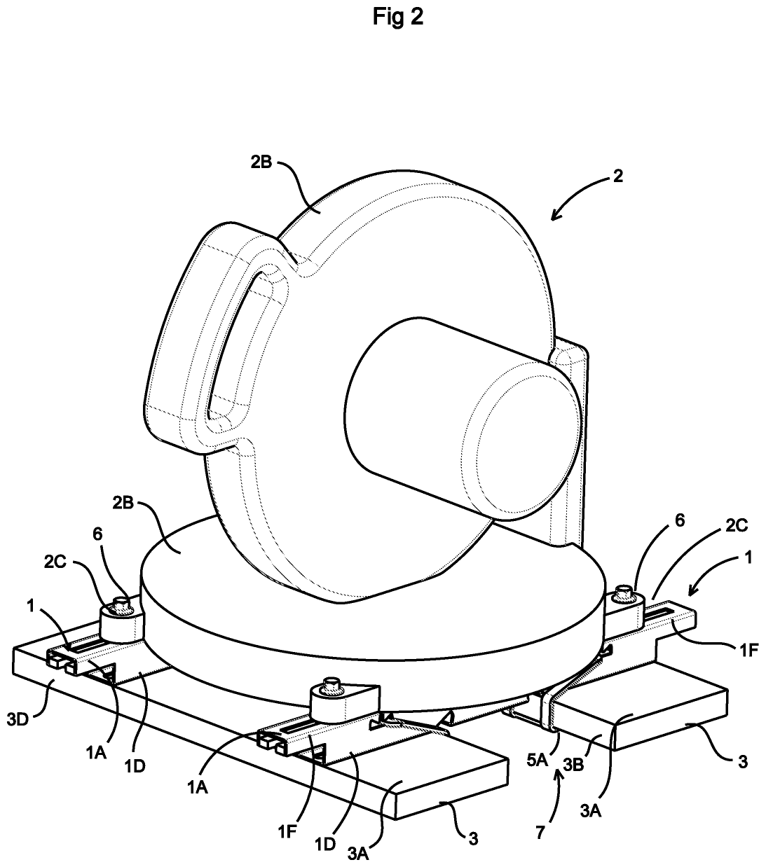

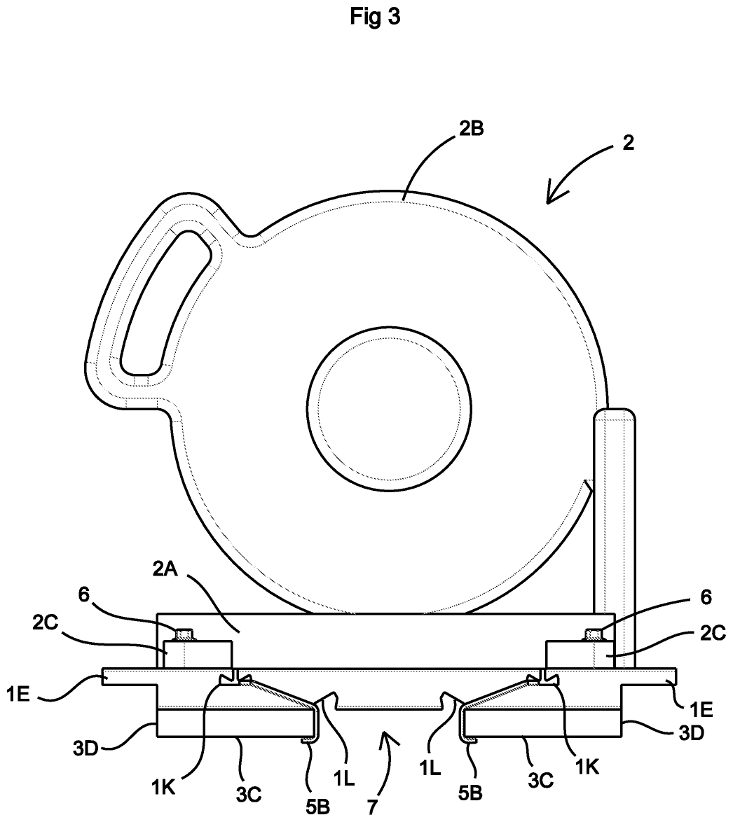

Referring to FIGS. 2-5 there is shown a power tool 2, in this instance a mitre saw having a base 2A and a mechanism 2B comprising a rotatable blade that can move towards and way from the base 2A in order to form cuts in a work piece supported on the base 2A.

The power tool 2 is securely mounted to vice jaws 3 of a workbench which may take the form as described in GB1267032, hereby incorporated by reference.

To mount the power tool 2 to the vice, the power tool 2 is mounted on top of the pair of crossbars 1 so as to rest on upper sides 1A. The crossbars 1 are fastened to the base 2A of the power tool by bolts 6 that pass through projecting bosses 2C of the power tool's base 2A, through slot 1F for engagement with fastening nuts 4 sitting with cavity 1H. The provision of the slot 1F and the ability for the fastening nut 4 to slide along rail 1G within cavity 1H accommodates fitting of tools 2 with different spacing between bosses 2C.

The two cross bars 1, with power tool 2 mounted thereon, are positioned on a work surface of the workbench defined by co-planer surfaces 3A of two spaced apart vice jaws 3. Each cross-bar 1 is supported at one end by a first surface 3A of one of the vice jaws 3 and at the other end on a second surface 3A the other vice jaw 3 so that the crossbars 1 extend over a gap 7 between the vice jaws 3. The swing arms 5, if not already in position, rotate downwards under gravity to depend from the crossbars 1 within the gap 7 with the opening 5B of hook portions of the swing arms 5 facing opposing inner gripping faces 3B of the vice jaws 2.

To securely retain the tool 2, the jaws 3 are closed together into the arrangement shown in FIGS. 2, 3 and 4 such as to tighten around the swing arms 5, with the crosspieces 2B lying under lower faces 3C of the jaws 3 to inhibit the tool 2 being removed from the vice through a upward sheering force on the tool.

Through this arrangement downward forces by/on the tool during use, including its weight will be transferred directly through the crossbars 1 onto the supporting surfaces 3A. The swing arms 5 are thus substantially isolated from these forces.

The lower portions 1D of the crossbars 1 are sized so as not to extend beyond the outer face 3D of jaws 3. This ensures that the cross-bars 1 do not obstruct rotation of handles (not shown) of the workbench used to open and close the vice jaws 3, whilst the protruding end portions 1E allow the crossbars 1 to accommodate tools 2 having a spacing between mounting points that is greater than the total width of the spaced jaws 3, i.e. distance between surface 3D of jaws 3, when tightened against the swing arms 5.

With reference to FIG. 6, when seating the tool 2 off the workbench on a surface without a gap 7, e.g. the floor or a table, the normal force on the swing arms 5 as they contact the surface causes them to rotate upwards until the crosspiece 2A are seating fully within slots 1L. With the swing arms 5 no longer proud of the lower surface 1B, the lower side 1B provides a stable supporting surface for the tool on the surface.

FIG. 7 illustrates an alternative arrangement in which the swing arms 5 are mounted into slots 1K so as to extend towards the longitudinal ends of the crossbars 1 with the openings of the hook portions 5C of respective crossbars 1 facing towards one another. The support 1 is tightened to the vice through moving the jaws 3 apart until their outer gripping faces 3D pass into opening 5C and tighten against the swing arms 5. When the support is placed on the floor or other like surface, the hooked ends of the swing arms 5 rotate outwards such that the crosspieces 2B sits under end portions 1E, facing the end of lower portion 1D, to lie above or level with lower surface 1B.

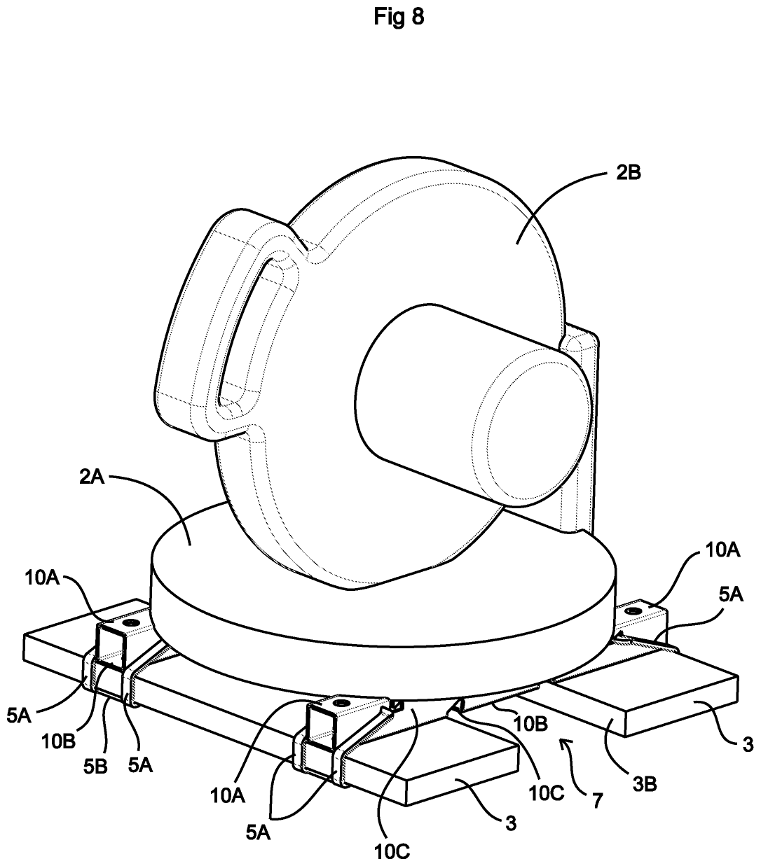

FIG. 8 illustrates an alternative embodiment in which an upper portion 10C of the crossbar 10 comprises a central recess arranged to receive the base of the tool 2 in order to inhibit lateral movement of the tool 2 across the crossbars 10. In this arrangement, as the position of the mounting points provided in the underside of the base 2A of the tool 2 is known, the crossbar 10 is provided with in-register apertures in the upper and lower sides 10A 10B that align with the mounting points. This allows a fastener to be passed from the underside 10B through the crossbar 10 for securing the tool 2 to each cross bars 10.

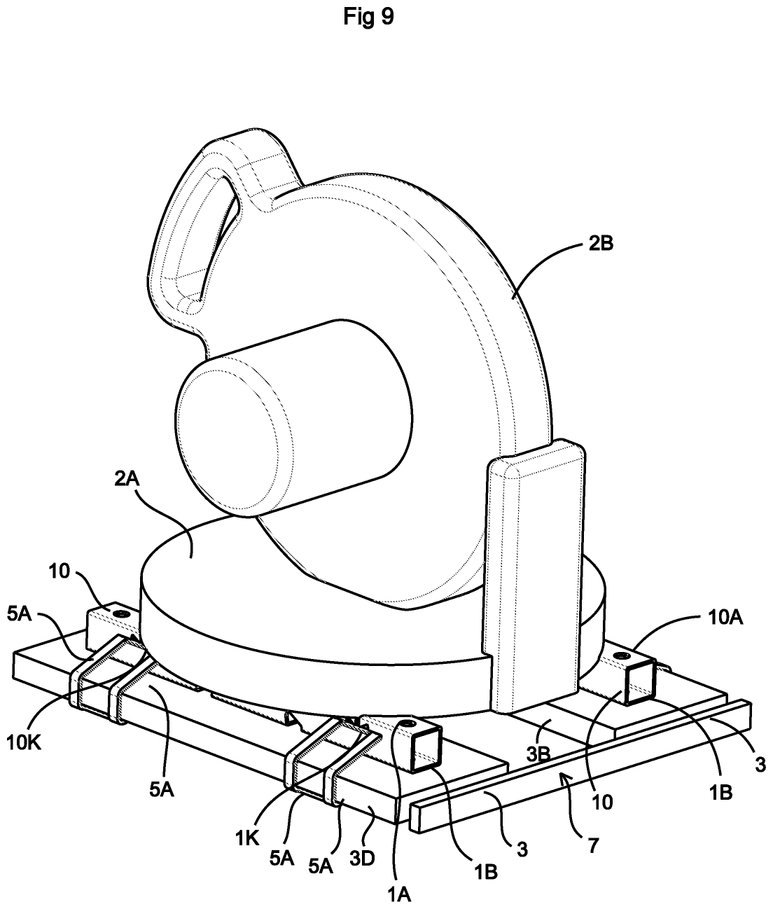

FIG. 9 illustrates an alternative arrangement of the second embodiment of support 10 in which the swing arms 5 are mounted to the cross bars 10 so as to be rotatable about an axis that extends substantially parallel to the longitudinal axis of the cross bars 10. The crossbars 10 are arranged such that each is supported on a separate vice jaw 3. As in the example of FIGS. 7 and 8, the opening 5C of the swing arm's 5 hook portions face inwards so as to engage the outer facing gripping surface 3D of the vice jaws 3 when the jaws 3 are moved apart. Nevertheless, the swing arms 5 may instead be arranged on the opposite side to engage the inner gripping surface 3B in a manner similar to that shown in FIG. 2.

Variations to the above embodiments are contemplated. For example, if the swing arms omit the cross piece 2A, allowing the base of arms 5A to swing past either side of the crossbars, the lower slots 1G can be omitted.

It will be appreciated that the support may take forms other than crossbars. For example the support may be of plate form, which may, for example substantially cover the whole of the base 2A of the tool 2.

An advantage of a releasable attachable vice support is that this allows the projection to be retro-fitted onto existing tools. Nevertheless, this may not always be preferred. Particularly for the manufacture of new tools, it may preferred instead to arranged the swing arms 5 to be mounted directed to the tool 2, omitting the cross-bars altogether. When mounted to the vice, the base of the tool 2A can rest directly against the supporting surface 3A.

To accommodate tools having very large spacing between mounting points, each of the cross bars may include a nested cross bar of similar shape but smaller dimension nested therein. Where it is desired to increase the length of the cross bars, the nested inner crossbar can be partly withdrawn. The nested crossbar may be temporarily fixed in either withdrawn or nested positions using, for example, a ball and detent mechanism.

It will be understood the terms such as upper, lower, top, bottom are described with reference to embodiments as depicted in the drawings, and that although in use the embodiments are expected to be used in the orientations depicted, it is possible they may be used in alternative orientations. As such, and for example, the upper surface 1A may not be uppermost when in use.

It will be appreciated that the invention may be used for securing other power tools that benefit from being securely mounted when used, such as, for example, chop saws, pillar drills and milling machines.

In an alternative arrangement, the lower surface of the crossbars may be provided with feet, in which case the swing arms need only recede upwards enough to no longer protrude beyond the feet.

Means other than a swing arm may be used, such a knob, button, block, bracket or other protrusion. Further, the support may only comprise a single protrusion arranged so as to be gripped on either side by opposing jaws 3.

The protrusions may be mounted to the cross bar by means other than the lateral slots.

The protrusion may be mounted to allow linear rather that rotational movement relative to the support. For example the lower face of the support may comprise a recess that holds the protrusion and spring arranged, when there is no counter force from a work surface, to bias the protrusion so as to travel linearly out of the recess.

Rather than providing a projection that retracts, the projection may instead be arranged to be releasably detached from a first position on the tool, e.g. extending from the base of the tool/support, and reattached, fastened or otherwise retained to the tool at or about a second position where it will not interfere either with the mounting of the tool on its base on a floor or table, or operation of the tool. For example, the base or other side of the tool/support may be provided with a recess in which the projection may be held, for example by a clip provided by the tool or friction fit. Alternatively, either the tool or support may be provided with an external clip or strap of the tool arranged to retain the projection to the tool, e.g. against the tool body.

The Abstract is provided with the understanding that it is not intended be used to interpret or limit the scope or meaning of the claims. In addition, in the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

Although specific embodiments of the subject matter have been disclosed, those having ordinary skill in the art will understand that changes can be made to the specific embodiments without departing from the scope of the disclosed subject matter. The scope of the disclosure is not to be restricted, therefore, to the specific embodiments, and it is intended that the appended claims cover any and all such applications, modifications, and embodiments within the scope of the present disclosure.

1-26. (canceled)

27. An apparatus comprising a tool adapted to be retained on a vice having vice jaws defining a supporting surface and gripping surfaces; the apparatus including a projection attached to the tool and arranged, when the tool is supported for use on the supporting surface, to allow at least one of the gripping surfaces to be tightened against it to retain the tool to the vice; and wherein the projection is moveable relative the tool in order that the projection can be supported to the tool in a stowed position when the tool is not being retained on the vice.

28. The apparatus according to claim 27 wherein the projection is retractable.

29. The apparatus according to claim 28 wherein the projection is adapted to retract in response to the weight of the tool being placed upon it.

30. The apparatus according to claim 27 wherein the projection is rotatably mounted to the tool.

31. The apparatus according to claim 27 wherein the projection is arranged, when the tool is on the supporting surface of the vice jaws, to face at least one of the gripping surfaces.

32. The apparatus according to claim 27 wherein the projection is releasably attachable to the tool.

33. The apparatus according to claim 27 wherein the projection comprises a portion that, when the tool is retained by the vice, extends across a side of the vice jaw that is opposite the supporting surface.

34. The apparatus according to claim 27 wherein the projection is arranged, when the tool is on the supporting surface, to extend between the vice jaws.

35. The apparatus according to claim 27, the tool comprising two retractable projections arranged such that a first jaw of the vice jaws tightens against a first of the two projections and a second jaw of the vice jaws tightens again a second of the projections.

36. The apparatus according to claim 27 wherein the tool comprises a support for mounting against the supporting surface of the vice jaws; a tool mechanism of the tool being arranged on a first side of the support, and the projection extending away from a second, opposite, side of the support.

37. The apparatus according to claim 36 wherein the support is releasably attachable to the tool.

38. The apparatus according to claim 36 wherein the projection is arranged to retract into the support.

39. The apparatus according to any claim 36 wherein the projection is hinged to the support.

40. The apparatus according to claim 36 wherein the support comprises retaining means to retain a fastener for fastening the support to a body of the tool, the retaining means allowing the fastener to move across a side of the support that faces the tool body.

41. The apparatus according to claim 36 wherein the support comprises a first side that, when in use, faces the vice and a second side that faces a tool body, and wherein the support is extendable such as to increase a dimension of the first and second sides.

42. The apparatus according to claim 41 wherein the support is telescopic.

43. A support for mounting a tool to a vice having vice jaws defining a supporting surface and gripping surfaces; the support arranged to be mounted against the supporting surface of the vice jaws; a tool mechanism of the tool being arranged on a first side of the support, the support comprising a projection extending away from a second opposite side of the support and arranged, when the tool is supported on the supporting surface, to allow at least one of the gripping surfaces to be tightened against it to retain the tool to the vice.

44. A support according to claim 43 arranged for releasable attachment to the tool.

45. A method for supporting a tool on a vice, the vice having vice jaws defining a supporting surface and gripping surfaces; the method comprising arranging the tool to be supported against the supporting surface and tightening at least one of the vice jaws' gripping surfaces against a projection connected to the tool to retain the tool to the vice; and wherein the projection can extend away from and retract towards the tool.

46. A method according to claim 45 wherein the projection is adapted to retract in response to the weight of the tool being placed upon it.
